(19) United States
(12) Patent Application Publication
(10) Pub. No.: US 2015/0106151 A1
(43) Pub. Date: Apr. 16, 2015

(54) Systems and Methods for Creating a Maturity Model Based Roadmap and Business Information Framework for Managing Enterprise Business Information

(71) Applicant: SNJK CONSULTING, US, Fremont, CA (US)

(72) Inventor: Janaki Thalli Krishnaswamy, Fremont, CA (US)

(73) Assignee: SNJK CONSULTING, US, Fremont, CA (US)

(21) Appl. No.: 14/481,191

(22) Filed: Sep. 9, 2014

Related U.S. Application Data
(60) Provisional application No. 61/889,157, filed on Oct. 10, 2013.

(51) Int. Cl. G06Q 10/06

(52) U.S. Cl. CPC G06Q 10/06315
USPC 705/7.25

(57) ABSTRACT

Systems and Methods for creating a maturity model based roadmap and business information framework for managing Enterprise Business information in an enterprise is provided by transforming Enterprise business information, system design information, business drivers, and solution needs into a capability roadmap by utilizing maturity models. The method and system map the current state of the Enterprise business information and system design information to maturity models and determine capability roadmap based on business drivers and business needs and thereupon determine one or more solutions. The business information framework enables setting up program and data governance along with guidelines for managing the Enterprise business information.

### CROSS-REFERENCE TO RELATED APPLICATION

The application claims benefit to U.S. Provisional Patent Application No. 61/889,157 filed on Oct. 10, 2013, which is incorporated by reference in its entirety.

### FIELD OF THE INVENTION

The presently disclosed embodiments are related to business information management in an enterprise. More particularly, the presently disclosed embodiments are related to systems and methods for establishing one or more strategies for the development of a business information framework in the enterprise.

### BACKGROUND

Any business enterprise has a large variety of data that continuously increases day by day that may be of critical importance for enhancing the efficiency of the enterprise. Such a variety of data may be stored in computing systems, databases or may be held by its employees that may be geographically distributed. In recent years, business enterprises have focused on creating information systems to analyze business operations and increase profitability. These information systems access business related information. The Enterprise business information includes data on a wide range of business activities such as inventory, sales records, etc. Even though such information is available, many executives have difficulty applying this vast amount of geographically distributed information to everyday business needs. Often, the volume of data simply overwhelms the average business user. Consequently, managers and executives may rely on special software tools and techniques to sort through and produce information useful to a business within a particular context.

Further there are also enterprise applications being commonly used by larger companies and organizations to run important aspects of their business. A typical enterprise application environment may include a database of business content, combined with end-user applications such as customer relationship management and business intelligence. Such environments are generally designed for handling complex Enterprise business information within a large organization. However it has been observed that the Enterprise business information issues continue to limit scalability & agility even with such environments and this result in a limited return on investment on the enterprise system and applications. Further, the integration of business data across multiple systems continues to be difficult and that subsequently leads to increased risk to compliance.

Since the organizations today have become increasingly interested in greater integration of their Enterprise business information with their business processes, therefore there exists a need for efficiently managing the Enterprise business information of an enterprise.

### SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

According to an embodiment, a computer implemented method comprises of receiving Enterprise business information and system design information and transforming the received information into a business information framework and a roadmap for managing heterogeneous Enterprise data. The method is implemented by means of a computer system having at least one processor and an internal memory. The method comprises of retrieving a Enterprise business information and a system design information by the computer system wherein the Enterprise business information and the system design information may either be stored in a plurality of databases or may be inputted by means of a plurality of computing devices communicatively coupled with the computer system. In an aspect, the Enterprise business information comprises of at least a master business data, a enterprise business data, and a business intelligence data. Further, the method comprises of parsing the received Enterprise business information and the system design information and thereupon determining a current state of the parsed Enterprise business information and a current state of the parsed system design information. The processor of the computer system then assesses and analyzes the Enterprise business information and the system design information along with the current state of all the parsed information. The purpose of assessing the Enterprise business information and the system design information is to analyze the information with respect to one or more maturity models and thereby determine one or more business drivers and one or more business needs. In an aspect, there is at least a maturity model for assessing master business data, a maturity model for assessing enterprise business data, and a maturity model for assessing business intelligence data. In an aspect, the step of assessing the Enterprise business information and the system design information comprises of mapping the identified current state of the Enterprise business information and the system design information to one of the one or more maturity models; determining one or more business drivers based on the parsed Enterprise business information and the current state of the parsed Enterprise business information for improving maturity level of the business data; and determining one or more business needs based on the mapping of the identified current state of the Enterprise business information and the system design information to the one of the one or more maturity models.

Once the business drivers and the business needs have been determined, and the current state of the information has been mapped to the one or more maturity models then the processor transforms the Enterprise business information and the system design information into a business information framework and a business roadmap. The step of transforming the Enterprise business information and the system design information comprise of determining one or more solution parameters of the Enterprise business information based on the one or more business drivers and the one or more business needs; determining one or more Enterprise business information capabilities based on the one or more solution parameters; mapping the one or more Enterprise business information capabilities to the one or more business drivers and one or more business needs; and mapping the one or more Enterprise business information capabilities to the one of the one or more maturity models.

In another embodiment, a system is provided for developing a Enterprise business information framework for managing heterogeneous Enterprise data. The system comprises of a memory and at least one processor. The memory stores one or more program modules including a state determination module, a maturity model module, a strategy module, and a modelling module. The processor is communicatively coupled with the memory and is enabled for accessing the data and executing the program modules stored in the memory. The system also includes a network interface unit for interacting with one or more databases, one or more servers, and one or more computing devices through which Enterprise business information and system design information may be retrieved. The Enterprise business information comprises of at least a master business data, a enterprise business data, and a business intelligence data. The processor is configured for parsing the retrieved Enterprise business information and the retrieved system design information. The processor is also configured for determining a current state of the parsed Enterprise business information and a current state of the parsed system design information. The processor upon determining the current state of the information assesses the Enterprise business information and the system design information with respect to the respective current states and on one or more maturity models. In an aspect, there is at least a maturity model for assessing master business data, a maturity model for assessing enterprise business data, and a maturity model for assessing business intelligence data. In an aspect, the processor for assessing the Enterprise business information and the system design information firstly, maps the identified current state of the Enterprise business information and the system design information to one of the one or more maturity models; determines one or more business drivers based on the parsed Enterprise business information and the current state of the parsed Enterprise business information for improving maturity level of the business data; and determines one or more business needs based on the mapping of the identified current state of the Enterprise business information and the system design information to the one of the one or more maturity models. The processor for transforming the Enterprise business information and the system design information into a business information framework and a business roadmap determines one or more solution parameters of the Enterprise business information based on the one or more business drivers and the one or more business needs; determines one or more Enterprise business information capabilities based on the one or more solution parameters; maps the one or more Enterprise business information capabilities to the one or more business drivers and one or more business needs; and maps the one or more Enterprise business information capabilities to the one of the one or more maturity models.

In yet another embodiment, a non-transient computer readable medium storing a plurality of computer executable instructions is described. The stored plurality of computer executable instructions upon execution by a computer processor cause the computer processor to retrieve a Enterprise business information and a system design information by the computer system, wherein the Enterprise business information and the system design information is stored in a plurality of databases or the Enterprise business information and the system design information is inputted by means of a plurality of computing devices communicatively coupled with the computer system, and wherein the Enterprise business information comprises at least a master business data, a enterprise business data, and a business intelligence data; parse the Enterprise business information and the system design information and determining by the processor, a current state of the parsed Enterprise business information and a current state of the parsed system design information; assess the business data based on one or more maturity models comprising mapping the identified current state of the Enterprise business information and the system design information to one of the one or more maturity models; determining one or more business drivers based on the parsed Enterprise business information and the current state of the parsed Enterprise business information for improving maturity level of the business data; and determining one or more business needs based on the mapping of the identified current state of the Enterprise business information and the system design information to the one of the one or more maturity models. The stored code upon execution transforms the Enterprise business information and the system design information into a business information framework and a business roadmap, comprising: determining one or more solution parameters of the Enterprise business information based on the one or more business drivers and the one or more business needs; determining one or more Enterprise business information capabilities based on the one or more solution parameters; mapping the one or more Enterprise business information capabilities to the one or more business drivers and one or more business needs; mapping the one or more Enterprise business information capabilities to the one of the one or more maturity models.

It is an object of the present invention to ensure a single consistent definition of the Enterprise business information for sharing throughout an enterprise.

It is another object of the present invention to minimize redundancy, disparity and errors in the Enterprise data.

It is another object of the present invention to ensure and enhance data quality of the Enterprise data.

It is another object of the present invention to enhance the scalability, flexibility, and robustness of the Enterprise data.

It is yet another object of the invention to enhance the security of the Enterprise data.

### BRIEF DESCRIPTION OF THE DRAWINGS

The accompanying drawings illustrate various embodiments of systems, methods, and embodiments of various other aspects of the invention. Any person with ordinary skills in the art will appreciate that the illustrated element boundaries (e.g., boxes, groups of boxes, or other shapes) in the FIGS. represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the FIGS. are not necessarily to scale, emphasis instead being placed upon illustrating principles.

FIG. 1a illustrates the components of Enterprise Business information.

FIG. 1b illustrates the components of System design information.

FIG. 2 illustrates a method for determining current state of the Enterprise Business information, current state of the System design information, and other essential information required for developing a roadmap and framework, according to an embodiment.

FIG. 3 illustrates a method of transforming the Enterprise business information for developing a roadmap.

FIG. 4 illustrates a method of transforming the roadmap into an Enterprise business framework.

FIG. 5 illustrates an exemplary environment for system and method for developing a business information framework and a roadmap for managing heterogeneous Enterprise data.

FIG. 6 illustrates a block diagram of a system for developing a business information framework and a roadmap for managing heterogeneous Enterprise business information according to an embodiment.

FIG. 7 illustrates an exemplary mapping of a current state of master business data with a maturity model.

FIG. 8 illustrates an exemplary mapping of a current state of enterprise business data with a maturity model.

FIG. 9 illustrates an exemplary mapping of a current state of business intelligence data with a maturity model.

FIG. 10 illustrates determining business needs and solution parameters according to an exemplary embodiment.

FIG. 11 illustrates an exemplary block diagram for retrieving business needs, business drivers and system capabilities for developing a business information roadmap.

FIG. 12 illustrates an exemplary mapping of business needs to a maturity model for managing master business data.

FIG. 13 illustrates an exemplary mapping of business needs to a maturity model for managing enterprise business data.

FIG. 14 illustrates an exemplary mapping of business needs to a maturity model for managing business intelligence data.

### DETAILED DESCRIPTION

Embodiments of the present disclosure will be described more fully hereinafter with reference to the accompanying drawings in which like numerals represent like elements throughout the several FIGS., and in which example embodiments are shown. Embodiments of the claims may, however, be embodied in many different forms and should not be construed as limited to the embodiments set forth herein. The examples set forth herein are non-limiting examples and are merely examples among other possible examples.

Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

References to “one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

A “network” refers to a medium that connects various computing devices, and application servers. Examples of a network include, but are not limited to, LAN, WLAN, MAN, WAN, and the Internet. Communication over the network may be performed in accordance with various communication protocols such as Transmission Control Protocol and Internet Protocol (TCP/IP), User Datagram Protocol (UDP), IEEE 802.11n communication protocols, or the like.

A “computing device” refers to a device with a processor/microcontroller and/or any other electronic component, or a device or a system that performs one or more operations according to one or more programming instructions. Examples of a computing device include, but are not limited to, a desktop computer, a laptop, a personal digital assistant (PDA), a tablet computer (e.g., iPad®, Samsung Galaxy Tab®), a smartphone, or the like.

The term “Master data” and “MDM data” are interchangeably used hereinafter. “Master Data Management” and “MDM” are used interchangeably hereafter.

The present disclosure describes method and system for managing Enterprise business information also known as Enterprise business information in an enterprise. The Enterprise business information in an enterprise is generally created, submitted, modified, and accessed by a plurality of entities. Enterprise business information is generally shared by the various employees and other related parties of an enterprise, generally across departments or even across geographic regions. Enterprise business information loss can result in significant financial losses for all parties involved, enterprises spend time and resources on careful and effective data modeling, solutions, security and storage. The present business information framework and roadmap are based on a method of mapping key Enterprise business information to a variety of maturity models. The Enterprise business information and system design information is of different types and hence different maturity models are used for mapping specific information.

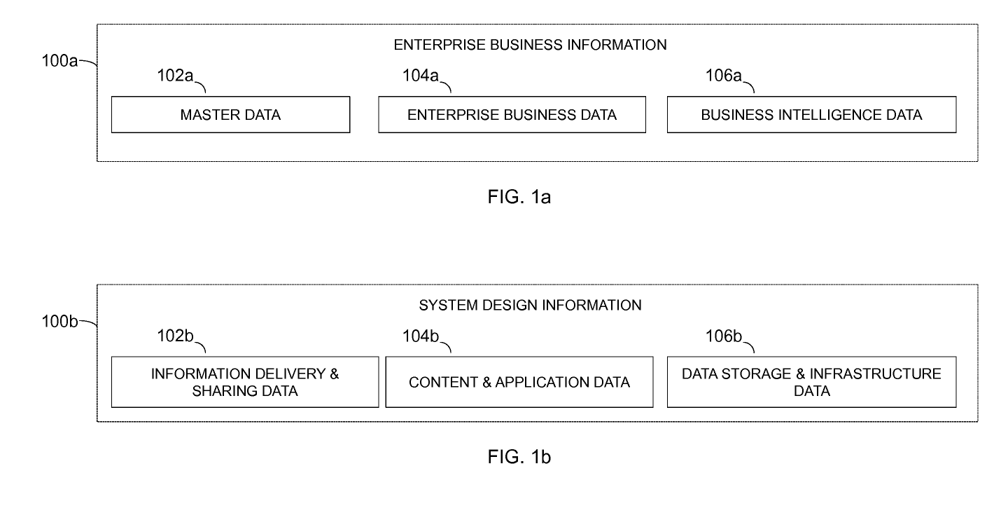

FIG. 1a illustrates the components of Enterprise Business information. Enterprise business information is generally classified into a plurality of categories according to organizational processes, resources and/or standards. In an aspect, the Enterprise business information 100a may comprise of a master business data 102a, an enterprise business data 104a, and a business intelligence data 106a. The Enterprise business information 100a may be stored in a plurality of heterogeneous sources such as various databases and servers. In an aspect, the Enterprise business information may be held by a plurality of personnel of an enterprise having access to at least one computing devices. The master business data 102a may be certain customer specific data or product specific data. For example, the master business data may be customer name, customer contact number, customer address, name of product to be sold, price of product to be sold, and the like. Master business data or Master data is the core data that is essential to operations in a specific business or business unit. The kinds of information treated as master data varies from one industry to another and even from one company to another within the same industry.

The enterprise business data 104a may be complete sales data of the enterprise, sales transactions data of the enterprise, sales data for a specific customer, work order related data, lead generation data, data related to calls made to a specific customer, and the like.

The business intelligence data 106a also referred to as BI data is the data based on the analysis of the master business data 102a and/or the enterprise business data 104a. The data may be analyzed using one or more analytical tools by various individuals in the enterprise. For example, analysis may be done on the sales data of the enterprise, analysis of the expenditure for lead generation, and the like.

FIG. 1b illustrates the components of System design information 100b. In an aspect, the System design information 100b comprises of Information delivery & Sharing data 102b, Content & Application data 104b, and Data storage & Infrastructure data 106b.

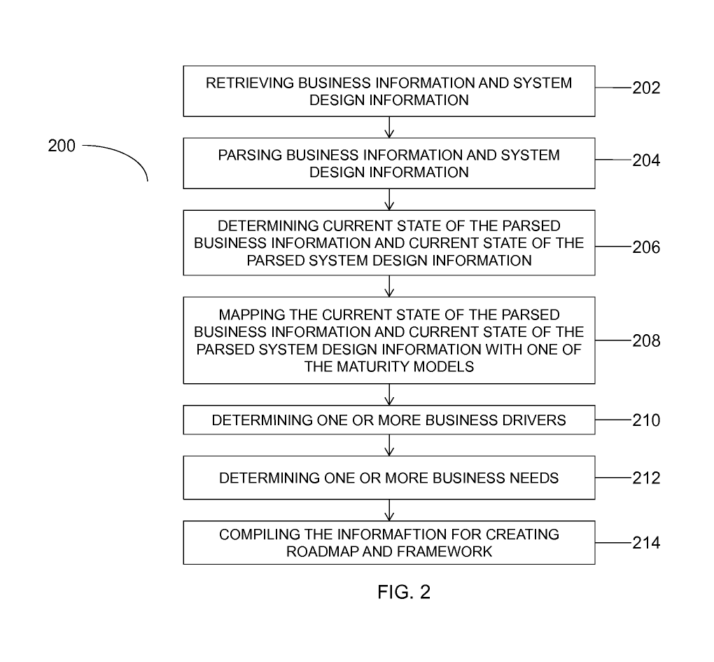

FIG. 2 illustrates a method 200 for determining current state of the Enterprise Business information, current state of the System design information, and other essential information required for developing a roadmap and framework. The computer implemented method 200 uses a computer system having at least one processor and an internal memory and Enterprise business information from a plurality of heterogeneous sources for developing the roadmap. The method comprises of a step of retrieving 202 Enterprise business information and a system design information. The Enterprise business information and the system design data may be stored in a plurality of databases or may be inputted by means of a plurality of computing devices communicatively coupled with the computer system. In an aspect, the Enterprise business information comprises at least a master business data, a enterprise business data, and a business intelligence data.

At step 204, the Enterprise business information and the system design information is parsed by the processor and then a current state of the parsed Enterprise business information and a current state of the parsed system design information is determined at step 206. In an aspect, the step of determining current state of Enterprise business information may include determining the data quality, data correctness, and the completeness of data. In another aspect, the current state of data may be determined by means of a software system configured to discover, profile, monitor, and cleanse data such as Informatica's Vibe™, Oracle Enterprise business information Quality Documentation™, and the like. In an aspect, the step of determining the current state of the Enterprise business information may comprise of identifying one or more Enterprise business information processes, one or more Enterprise business information tools, one or more management methodologies, and data quality of the Enterprise business information based on the Enterprise business information and one or more data governance processes. The identified current state of the Enterprise business information and the system design information is also mapped to the one of the one or more maturity models described below.

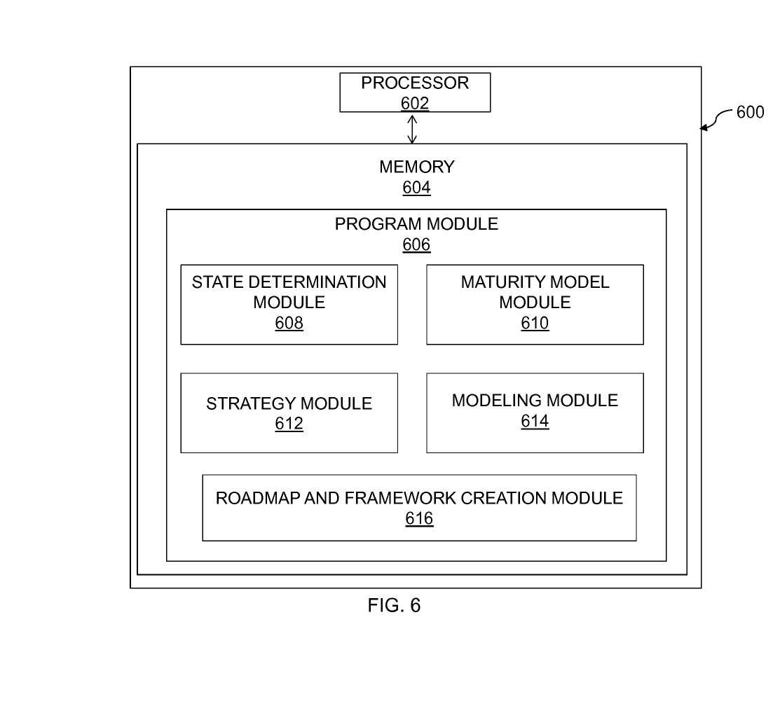

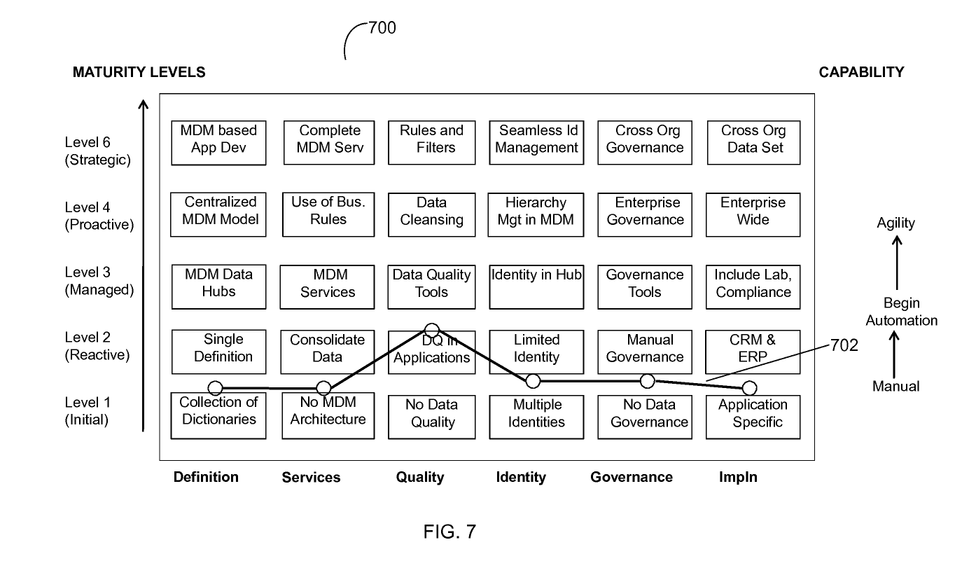

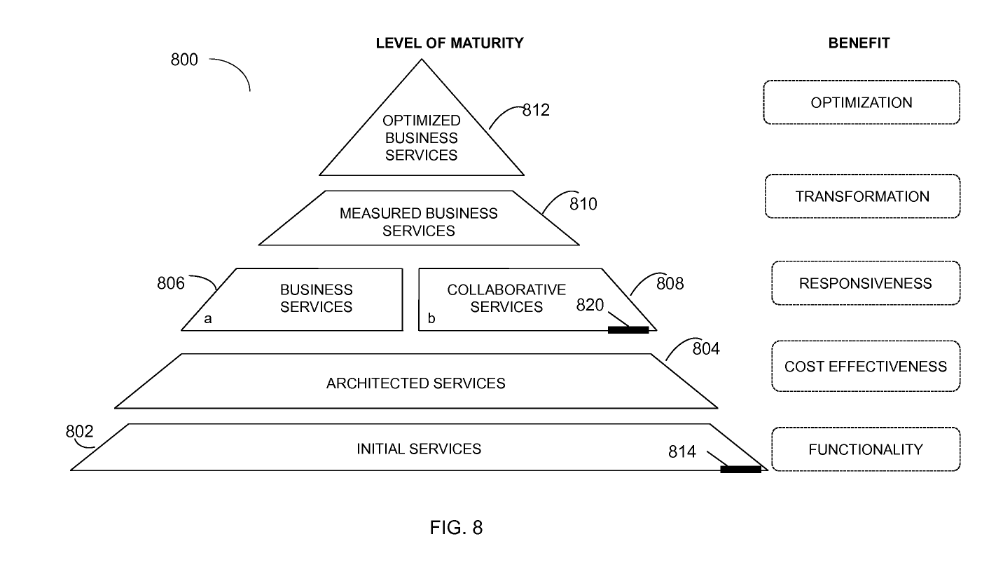

Once the current state of the Enterprise business information and the system design information is determined the processor assesses the business data based on one or more maturity models. FIG. 6, FIG. 7 and FIG. 8 as described below are utilized for assessing the data. The assessing of Enterprise business information comprises of mapping 208 the identified current state of the Enterprise business information and the system design information to one of the one or more maturity models. In an aspect, the step of assessing the enterprise business data may comprise of assessing the enterprise business data in terms of initial services, architected services, business services, collaborative services, measured services, and optimized business services.

A maturity model, also called a maturity grid, is an assessment tool for evaluating an organization's level of progress towards a goal. The model, which is a matrix laid out in rows and columns, typically lists the criteria that will be evaluated in the left-hand column. Each column's corresponding row has cells that describe, in a few words, the typical behavior exhibited by an organization at each level of development. Typically a maturity model has ten rows or less, with the first row defining entry level and the last row defining fully-developed best practice. Maturity models can be used to provide an organization with an initial benchmark for how close to ‘fully developed’ an organization is in regards to the criteria being assessed. They are also useful tools for leading discussions and providing management with roadmap for next steps.

Further, at step 210 one or more business drivers are determined based on the parsed Enterprise business information and the current state of the parsed Enterprise business information for improving maturity level of the business data in view of the maturity model used for mapping the data.

Then at step 212, one or more business needs are determined based on the one or more business drivers.

Finally, at step 214 the mapping between current state of the business information and system design information, the business drivers and the business needs are compiled together for providing an input for developing the roadmap and the business information framework. In an aspect, the method may also comprise of determining one or more challenges associated with Enterprise business information management. In another aspect, the method may also comprise of determining one or more impacts of not having the business information framework based on one or more tests based on a set of one or more predetermined parameters.

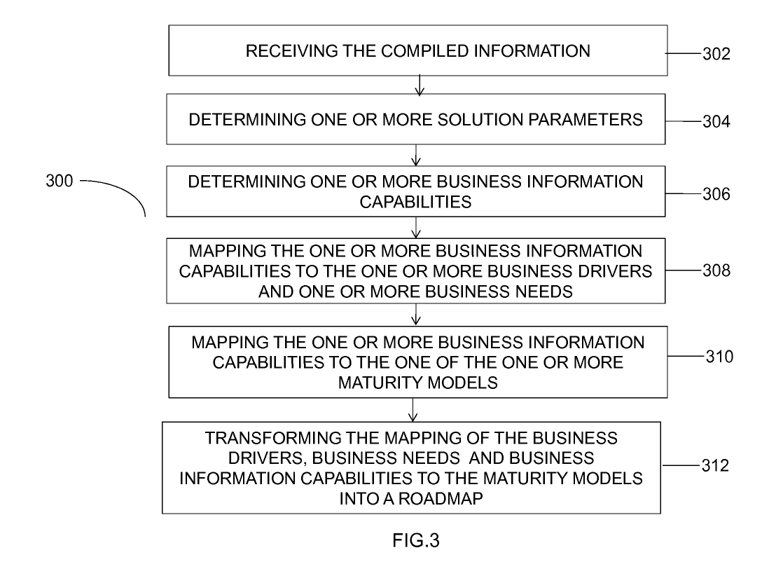

FIG. 3 illustrates a method of transforming the Enterprise business information for developing a roadmap. The transformation process retrieves the information compiled FIG. 2. Then, the transformation process may comprise of determining at step 304, one or more solution parameters of the Enterprise business information based on the one or more business drivers and the one or more business needs. Then one or more Enterprise business information capabilities may be determined at step 306 based on the one or more solution parameters. In an aspect, the step of determining one or more Enterprise business information capabilities may further comprise of determining the master data capabilities, the enterprise business data capabilities, and the business intelligence data capabilities based on the one or more solution parameters.

Such one or more Enterprise business information capabilities may then be mapped to the one or more business drivers and one or more business needs at step 308. The Enterprise business information capabilities may be mapped 310 to the one or more maturity models. In an aspect, the step of mapping the one or more Enterprise business information capabilities to the enterprise maturity model may comprise of mapping the master data capabilities, the enterprise business data capabilities, and the business intelligence data capabilities to the corresponding maturity models.

Finally at step 312, the mapping between the business information capabilities to the one or more business drivers and the mapping between the business needs and the business information capabilities to the one or more maturity models are transformed into a roadmap for managing the enterprise business information according to the business and present system capabilities.

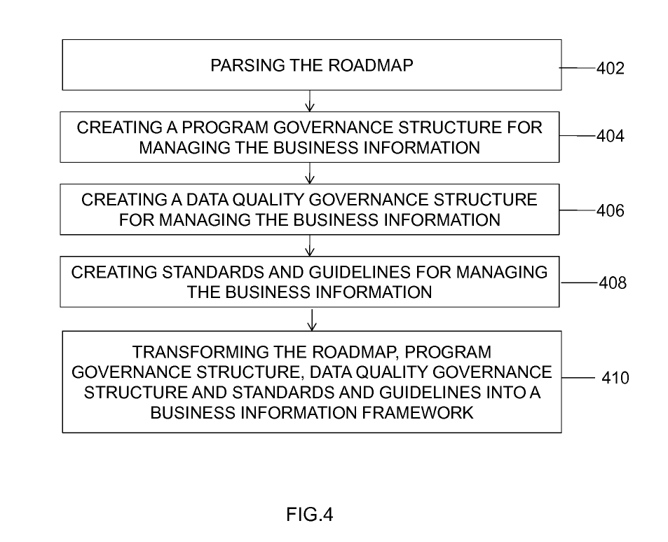

FIG. 4 illustrates a method of transforming the roadmap into an Enterprise business framework. At step 402, the roadmap developed in FIG. 3 is parsed. Then at step 404, based on the roadmap and information retrieved from the roadmap a business program governance structure is created at step 404, a business data quality governance structure is created at step 406, and one or more business standards and business guidelines are created at step 408. Finally at step 410, the business program governance structure, the business data quality governance structure, and the one or more business standards and business guidelines are transformed into a business information framework. Such business information framework may then be utilized in managing the enterprise business information.

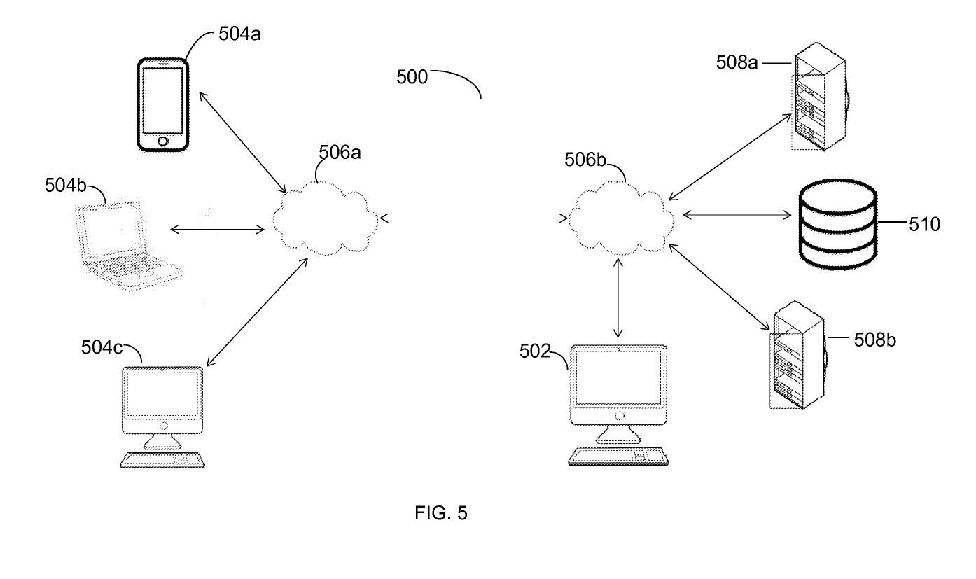

FIG. 5 illustrates an exemplary environment for system and method for developing a business information framework and a roadmap for managing heterogeneous Enterprise data. The enterprise business information and system design information may be retrieved from a plurality of servers (508a, 508b) and one or more databases (510). In an aspect, the plurality of databases may be heterogeneous databases. The enterprise business information and system design information may also be inputted by users within the enterprise by means of a plurality of communication devices (504a, 504b, 504c). An exemplary system (502) may then be utilized for processing the retrieved information and developing the roadmap and business information framework according to the various method steps.

FIG. 6 illustrates a block diagram of a system for developing a business information framework and a roadmap for managing heterogeneous Enterprise business information according to an embodiment. The system comprises of a processor (602) of processing the business information retrieved from a plurality of sources and is also enabled for accessing an internal memory (604) for executing one or more modules stored therein. The processor (602) may retrieving Enterprise business information and system design information stored in a plurality of databases or the Enterprise business information may be inputted by one or more computing devices communicatively coupled with the system. In an aspect, the Enterprise business information comprises at least a master business data, a enterprise business data, and a business intelligence data.

The memory (604) is configured for storing one or more program modules (606) including a state determination module (608), a maturity model module (610), a strategy module (612), and a modelling module (614). In an aspect, the memory may also stored the Enterprise business information being retrieved from the plurality of sources for executing the one or more program modules.

The processor (602) is configured for parsing the Enterprise business information and the system design information and for determining a current state of the parsed Enterprise business information and a current state of the parsed system design information. The processor (602) may also access the enterprise business information based on one or more maturity models. The processor may assess the enterprise business information by mapping the identified current state of the Enterprise business information and the system design information to one of the one or more maturity models; determining one or more business drivers based on the parsed Enterprise business information and the current state of the parsed Enterprise business information for improving maturity level of the business data; and determining one or more business needs based on the one or more business drivers and the mapping of the identified current state of the Enterprise business information and the system design information to the one of the one or more maturity models.

The processor (602) the n transforms the Enterprise business information and the system design information into a business information framework and a business roadmap by determining one or more solution parameters of the Enterprise business information based on the one or more business drivers and the one or more business needs; determining one or more Enterprise business information capabilities based on the one or more solution parameters; mapping the one or more Enterprise business information capabilities to the one or more business drivers and one or more business needs; and mapping the one or more Enterprise business information capabilities to the one of the one or more maturity models. In an aspect, the business information framework comprises of a business milestone, a business roadmap and a system capabilities roadmap.

FIG. 7 illustrates an exemplary mapping of a current state of master business data with a maturity model. The maturity model for assessing and mapping the master business data comprises of various dimensions namely definition, services, quality, identity, governance, and implementation. The current state of the master business data is mapped to this maturity model.

As illustrated in FIG. 7, the definition dimension captures data model maturity of the master data. At level 1, there is a collection of heterogeneous dictionaries that means that there are many definitions of a customer in a plurality of systems. At Level 2, there exists a single definition of the master data i.e. there is a single basic definition of a customer, however, the data and other useful attributes are in multiple systems. At Level 3, data from multiple transactional systems are consolidated into multiple master data hubs, most often with data synchronization across the hubs. At Level 4, Master data and definitions are consolidated in one master data hub with data published to all consuming systems. At level 5, transactional systems not only consume master data, but even processes and user interface are developed around the master data definition and the master data.

Services describe the Maturity of integrations with source and consuming systems. At level 1, Master data is exchanged manually or through point to point file exchanges between transactional systems. At Level 2, there is a single system that consolidates data and publishes it to other systems. No MDM services or functionality at this level. At Level 3, MDM functionality such as matching, merging, etc are supported. Integration with consuming systems is typically through web services. At Level 4, Business rules are used to enhance services offered by the MDM system. At level 5, MDM services and master data are exposed to systems outside of the organization. Typically used by data vendors to expose master data.

Data Quality describes Maturity of data quality tools and services. At level 1, there is very little functionality in terms of data quality checks, even in the transactional systems. At Level 2, Data quality is enforced by business rules in transactional systems, typically at entry points. Data quality is also built in ETLs to BI systems. At Level 3, Data quality tools are used to proactively or reactively improve quality of master data. Data profiling and cleansing may be done manually. At Level 4, Data profiling and cleansing tools are used to perform ongoing matching, merging, standardization, etc. Data quality is measured regularly. At level 5, Additional business rules and filters are employed to fine tune data profiling and cleansing. Typically employed during data acquisition.

Identity describes maturity of Identity, relationships, and hierarchy of MDM data. At level 1, the same MDM element (eg. customer) is given unique identity in each transaction system, resulting in multiple identities within the enterprise. At Level 2, Data and hence identity is consolidated in a few systems (ie multiple hubs). Transaction systems may continue to have separate identities. At Level 3, Data is maintained in the hub. Identity of data in the hub is published to all consuming systems. Relationships are also maintained in the hub. At Level 4, Complex relationships and hierarchies are maintained in the hub. Hierarchies are managed and published by the hub. At level 5, Identity and profile of MDM data is integrated with identity management systems (eg. Customer profile is integrated with customer login).

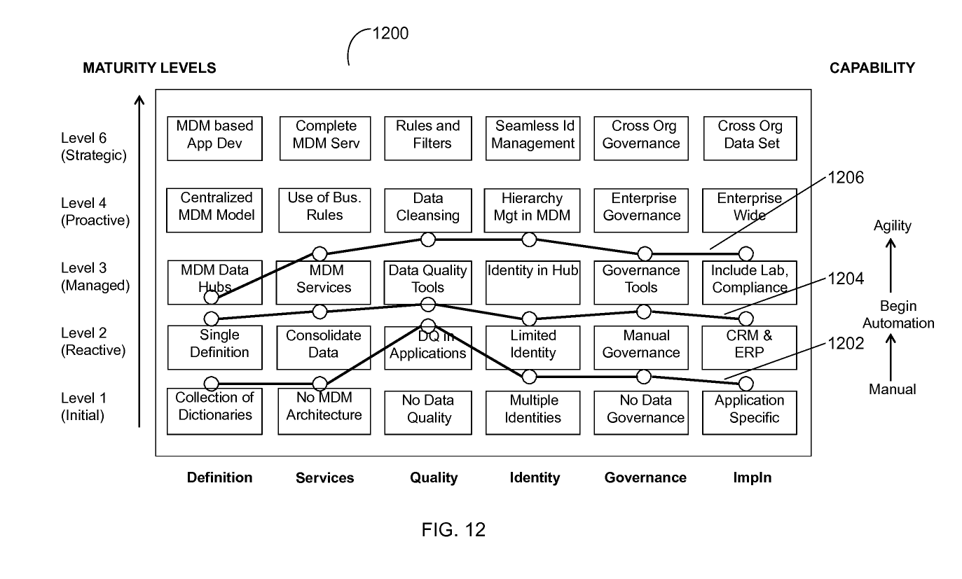

Governance describes maturity of Data governance in the enterprise. At level 1, there is little or no governance of data. At Level 2, Some processes for data change management and ongoing data quality control are in place. Primarily reactive data governance. At Level 3, Data governance tools, ongoing data quality metrics and dashboards are used to proactive measure and improve data quality. At Level 4, Governance processes, organization, and tools are used widely in the enterprise. Governance is sponsored and tracked at the highest levels. At level 5, Quality of data is governed beyond the enterprise, including external partners, etc. FIG. 12 illustrates an exemplary mapping of business needs to a maturity model for managing master business data. The described maturity model is accordingly mapped to each of the derived business needs and capabilities according to the various milestones set by the enterprise. In addition to this organizational and process aspects of governance may covered separately.

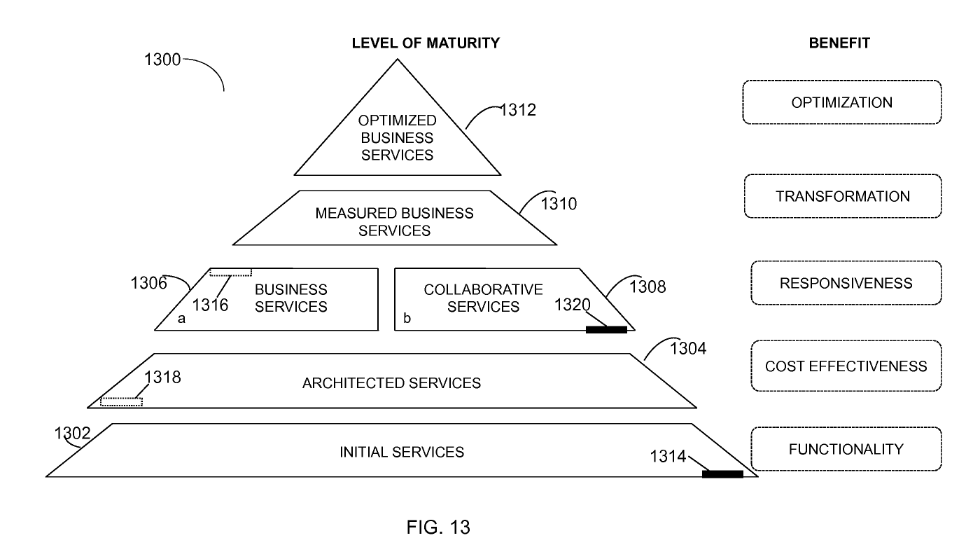

FIG. 8 illustrates an exemplary mapping of a current state of enterprise business data with a maturity model. The maturity model described in FIG. 8 is a service oriented architecture maturity model that is widely used in the field. The current state of the enterprise business data is mapped to this maturity model. FIG. 13 illustrates an exemplary mapping of business needs to the maturity model for managing enterprise business data. The described maturity model is accordingly mapped to each of the derived business needs and capabilities according to the various milestones set by the enterprise.

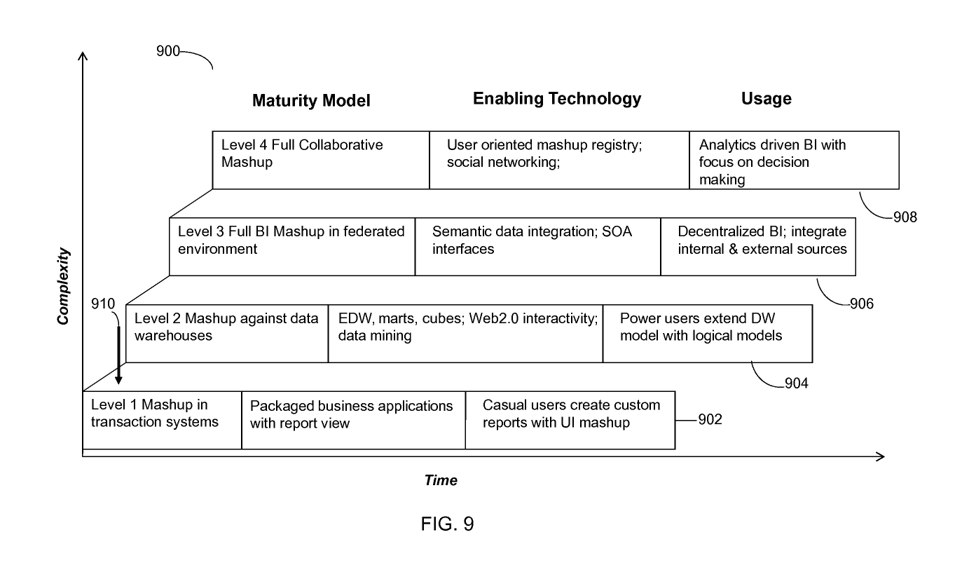

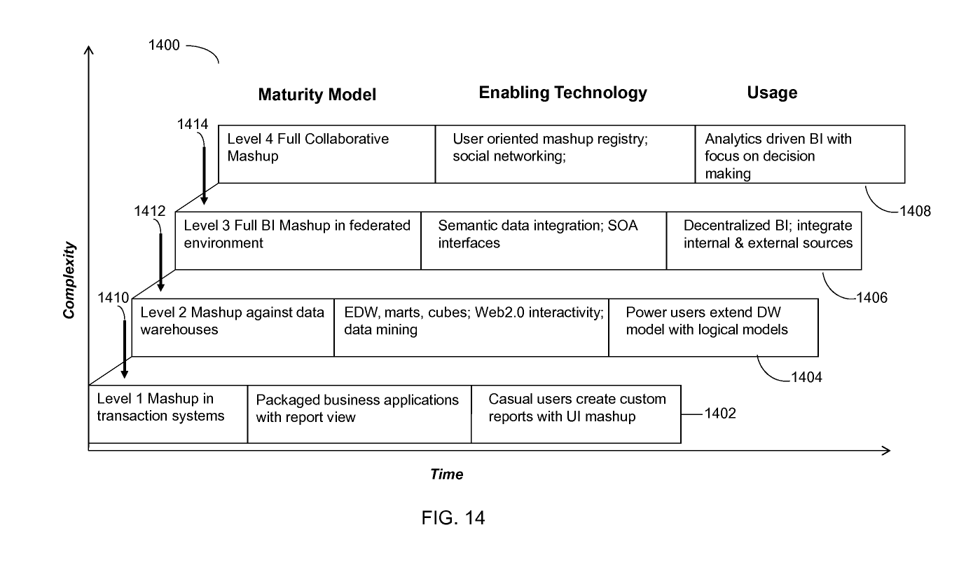

FIG. 9 illustrates an exemplary mapping of a current state of business intelligence data with a maturity model. The maturity model described in FIG. 9 is a BI mashup maturity that is widely used in the field. The current state of the business intelligence data is mapped to this maturity model. FIG. 14 illustrates an exemplary mapping of business needs to a maturity model for managing business intelligence data. The described maturity model is accordingly mapped to each of the derived business needs and capabilities according to the various milestones set by the enterprise.

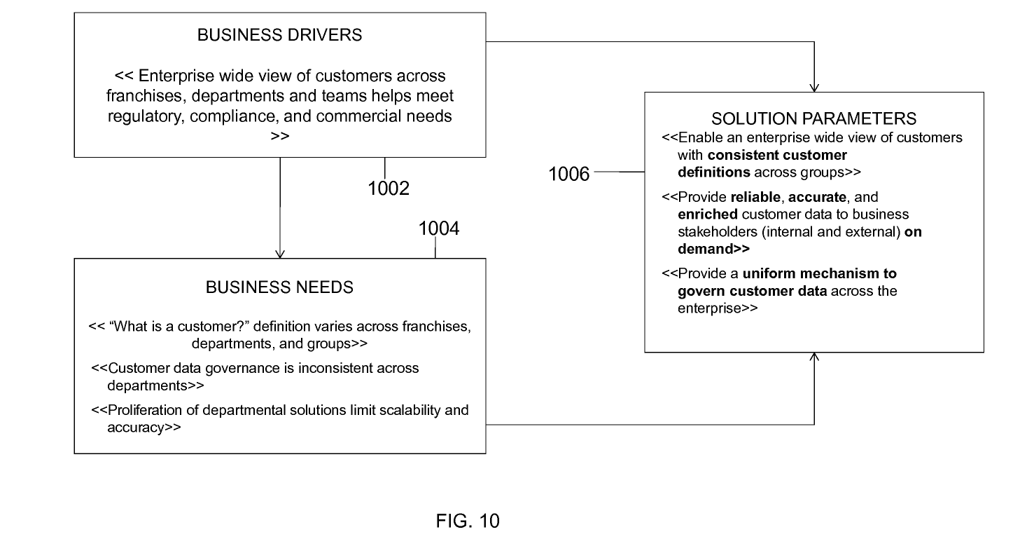

FIG. 10 illustrates determining business needs and solution parameters according to an exemplary embodiment. In block 1002, retrieved business drivers are present, for example, the business drivers may be Enterprise wide view of customers across franchises, departments and teams helps meet regulatory, compliance, and commercial needs. In block 1004, retrieved business needs are present. For example, the business needs may be defining a customer that varies across franchises, departments, and groups. The Customer data governance is inconsistent across departments. And, the Proliferation of departmental solutions limit scalability and accuracy. Based on the business drivers and the retrieved business needs a set of solution parameters may be derived. For example, the derived solution parameters may be enable an enterprise wide view of customers with consistent customer definitions across groups, Provide reliable, accurate, and enriched customer data to business stakeholders (internal and external) on demand, Provide a uniform mechanism to govern customer data across the enterprise. Solution capabilities are determined based on business drivers (1002), business needs (1004), and solution parameters (1006). The capabilities are prioritized based on the business drivers, business needs, and the complexity of the solution parameters. The business information roadmap is the prioritized list of capabilities along with the corresponding business needs.

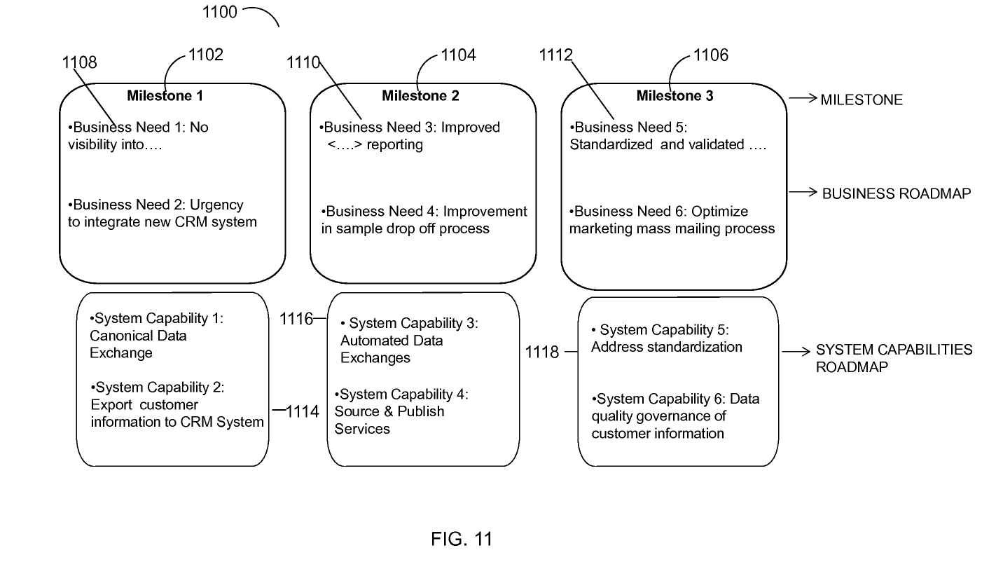

FIG. 11 illustrates an exemplary block diagram for retrieving business needs, business drivers and system capabilities for developing a business information roadmap. In an aspect, the roadmap may be a set of sequential milestones such as milestone 1 (1102), milestone 2 (1104) and milestone 3 (1106). Each milestone may in turn be a set of business needs and system capabilities. For example, Milestone 1 (1102) may include business need 1 that is there may be no visibility into the customer data and business need 2 that is there may be a need to integrate a new CRM system. Milestone 2 (1104) may include business need 3 that is there may be for improved reporting for various events and business need 4 that is there may be a need for improvement in sample drop off process. Milestone 3 (1106) may include business need 5 that is there may be for Standardized and validated process and business need 6 that is there may be a need for Optimizing the marketing mass mailing process. Each milestone also includes corresponding system capabilities for achieving the business needs. For example, Milestone 1 may include a system capability 1 that is canonical data exchange and a system capability 2 that is Exporting customer information to a CRM System. Milestone 2 may include a system capability 3 that is Automated Data Exchange and a system capability 4 that is Source & Publish services. Milestone 3 may include a system capability 5 that is Address standardization and a system capability 6 that is Data quality governance of customer information.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Embodiments of the present invention may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

Moreover, although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A computer implemented method of developing a business information framework for managing heterogeneous Enterprise business information by using a computer system having at least one processor and an internal memory, the method comprising the steps of:
retrieving a Enterprise business information and a system design information by the computer system, wherein the Enterprise business information and the system design information is stored in a plurality of databases or the Enterprise business information and the system design information is inputted by means of a plurality of computing devices communicatively coupled with the computer system, and wherein the Enterprise business information comprises at least a master business data, a enterprise business data, and a business intelligence data;
parsing the Enterprise business information and the system design information and determining by the processor, a current state of the parsed Enterprise business information and a current state of the parsed system design information;
assessing by the processor, the business data based on one or more maturity models, comprising
mapping the identified current state of the Enterprise business information and the system design information to one of the one or more maturity models;
determining one or more business drivers based on the parsed Enterprise business information and the current state of the parsed Enterprise business information for improving maturity level of the business data; and
determining one or more business needs based on the one or more business drivers and the mapping of the identified current state of the Enterprise business information and the system design information to the one of the one or more maturity models;
transforming by the processor, the Enterprise business information and the system design information into a business roadmap and a business information framework, comprising:
determining one or more solution parameters of the Enterprise business information based on the one or more business drivers and the one or more business needs;
determining one or more Enterprise business information capabilities based on the one or more solution parameters;
mapping the one or more Enterprise business information capabilities to the one or more business drivers and one or more business needs;
mapping the one or more Enterprise business information capabilities to the one of the one or more maturity models.

2. The method as claimed in claim 1, wherein the step of identifying the current state of the retrieved Enterprise business information comprises
identifying one or more Enterprise business information processes, one or more Enterprise business information tools, one or more management methodologies, and data quality from the retrieved Enterprise business information based on the Enterprise business information and one or more data governance processes.

3. The method as claimed in claim 1, further comprising determining one or more challenges associated with the one or more Enterprise business information management.

4. The method as claimed in claim 1, further comprising determining one or more impacts of not having the business information framework based on one or more tests based on a set of one or more predetermined parameters.

5. The method as claimed in claim 1, wherein the step of mapping the identified current state of the Enterprise business information to the enterprise maturity model comprises mapping the current state of the master data, the enterprise business data, and the business intelligence data to corresponding maturity models.

6. The method as claimed in claim 5, wherein the step of mapping the current state of the master data comprises mapping definition, services, quality, identity, governance and implementation of the master data to the current state of the master data.

7. The method as claimed in claim 5, wherein the step of mapping the current state of the enterprise business data comprises assessing the enterprise business data in terms of an integration maturity model.

8. The method as claimed in claim 7, wherein the step of assessing the enterprise business data comprises assessing the enterprise business data in terms of initial services, architected services, business services, collaborative services, measured services, and optimized business services.

9. The method as claimed in claim 5, wherein the step of mapping the current state of the enterprise business data comprises assessing business intelligence data in terms of a mash up maturity model.

10. The method as claimed in claim 1, wherein the step of determining one or more Enterprise business information capabilities further comprises determining the master data capabilities, the enterprise business data capabilities, and the business intelligence data capabilities based on the one or more solution parameters.

11. The method as claimed in claim 10, wherein the step of mapping the one or more Enterprise business information capabilities to the enterprise maturity model, comprises mapping the master data capabilities, the enterprise business data capabilities, and the business intelligence data capabilities to the corresponding maturity models.

12. The method as claimed in claim 1, wherein the step of developing a business information framework comprises identifying a business program governance structure, a business data quality governance structure, one or more business standards, and one or more business guidelines.

13. The method as claimed in claim 1, further comprising
creating a program governance structure for managing the Enterprise data;
creating a data quality governance structure for managing the Enterprise data;
creating standards and guidelines for managing the Enterprise data.

14. The method as claimed in claim 1, wherein the business information framework comprises of a business milestone, a business roadmap and a system capabilities roadmap.

15. A system for developing a business information framework for managing heterogeneous Enterprise data, the system comprising:
a memory configured for storing one or more program modules including a state determination module, a maturity model module, a strategy module, and a modelling module;
at least one processor configured for accessing the memory and executing the one or more modules of the program module;
wherein the at least one processor of the computer system is configured for:
retrieving a Enterprise business information and a system design information, wherein the Enterprise business information is stored in a plurality of databases or the Enterprise business information is inputted by one or more computing devices communicatively coupled with the system, and wherein the Enterprise business information comprises at least a master business data, a enterprise business data, and a business intelligence data;
parsing the Enterprise business information and the system design information and determining by the processor, a current state of the parsed Enterprise business information and a current state of the parsed system design information;
assessing by the processor, the business data based on one or more maturity models, comprising
mapping the identified current state of the Enterprise business information and the system design information to one of the one or more maturity models;
determining one or more business drivers based on the parsed Enterprise business information and the current state of the parsed Enterprise business information for improving maturity level of the business data; and
determining one or more business needs based on the one or more business drivers and the mapping of the identified current state of the Enterprise business information and the system design information to the one of the one or more maturity models;
transforming by the processor, the Enterprise business information and the system design information into a business information framework and a business roadmap, comprising:
determining one or more solution parameters of the Enterprise business information based on the one or more business drivers and the one or more business needs;
determining one or more Enterprise business information capabilities based on the one or more solution parameters;
mapping the one or more Enterprise business information capabilities to the one or more business drivers and one or more business needs;
mapping the one or more Enterprise business information capabilities to the one of the one or more maturity models.

16. The system as claimed in claim 15, wherein the plurality of databases may be heterogeneous databases.

17. The system as claimed in claim 15, wherein the system further comprises a random access memory for storing the Enterprise business information being retrieved from the plurality of databases for executing the one or more program modules.

18. The system as claimed in claim 15, wherein the business information framework comprises of a business milestone, a business roadmap and a system capabilities roadmap.

19. The system as claimed in claim 15, wherein the business roadmap comprises of
a program governance structure for managing the Enterprise data;
a data quality governance structure for managing the Enterprise data; and
one or more standards and guidelines for managing the Enterprise data.

20. A non-transient computer readable medium storing a plurality of computer executable instructions that upon execution of the code by a computer processor, causes the computer processor to:
retrieving a Enterprise business information and a system design information by the computer system, wherein the Enterprise business information and the system design information is stored in a plurality of databases or the Enterprise business information and the system design information is inputted by means of a plurality of computing devices communicatively coupled with the computer system, and wherein the Enterprise business information comprises at least a master business data, a enterprise business data, and a business intelligence data;
parsing the Enterprise business information and the system design information and determining by the processor, a current state of the parsed Enterprise business information and a current state of the parsed system design information;
assessing by the processor, the business data based on one or more maturity models, comprising
mapping the identified current state of the Enterprise business information and the system design information to one of the one or more maturity models;
determining one or more business drivers based on the parsed Enterprise business information and the current state of the parsed Enterprise business information for improving maturity level of the business data; and
determining one or more business needs based on the one or more business drivers and the mapping of the identified current state of the Enterprise business information and the system design information to the one of the one or more maturity models;
transforming by the processor, the Enterprise business information and the system design information into a business information framework and a business roadmap, comprising:
determining one or more solution parameters of the Enterprise business information based on the one or more business drivers and the one or more business needs;
determining one or more Enterprise business information capabilities based on the one or more solution parameters;
mapping the one or more Enterprise business information capabilities to the one or more business drivers and one or more business needs;
mapping the one or more Enterprise business information capabilities to the one of the one or more maturity models.
